(19) United States
(12) Patent Application Publication
(10) Pub. No.: US 2022/0318454 A1
(43) Pub. Date: Oct. 6, 2022

(54) METHOD AND SYSTEM FOR WIND STRESS COEFFICIENT EXPRESSION BY COMPREHENSIVELY CONSIDERING IMPACTS OF WIND SPEED, FETCH AND WATER DEPTH

(71) Applicant: NANJING HYDRAULIC RESEARCH INSTITUTE, Nanjing, Jiangsu (CN)

(72) Inventors: Shiqiang WU, Nanjing, Jiangsu (CN); Xiufeng WU, Nanjing, Jiangsu (CN); Ang GAO, Nanjing, Jiangsu (CN); Chenhui WU, Nanjing, Jiangsu (CN); Jiangyu DAI, Nanjing, Jiangsu (CN); Fangfang WANG, Nanjing, Jiangsu (CN); Yu ZHANG, Nanjing, Jiangsu (CN); Zhun XU, Nanjing, Jiangsu (CN); Qianqian YANG, Nanjing, Jiangsu (CN); Lei YU, Nanjing, Jiangsu (CN)

(21) Appl. No.: 17/617,890

(22) PCT Filed: Jan. 28, 2021
(86) PCT No.: PCT/CN2021/074176

§ 371 Date: Dec. 9, 2021

(30) Foreign Application Priority Data
May 13, 2020 (CN) 202010402840.6

(51) Int. Cl. G06F 30/20

(52) U.S. Cl. CPC G06F 30/20; G06F 2111/10

(57) ABSTRACT

The present invention discloses a method and system for a wind stress coefficient expression by comprehensively considering impacts of an average wind speed, a fetch and a water depth, and relates to the field of wind-wave-current numerical simulation studies. Based on a wind-wave-current coupling interaction mechanism in lakes, oceans and other waters, two dimensionless numbers that can represent a wind-wave-current interaction strength: a fetch Froude number and a fetch Reynolds number, are constructed, a form of a wind stress coefficient expression with an undetermined coefficient is established, and then the undetermined coefficient is obtained by using a nonlinear regression method with reference to experimental and measured data to obtain a final wind stress coefficient expression. The present invention overcomes the shortcomings that a conventional wind stress coefficient expression considers only an impact of a single factor of wind speed, and breaks through the limitation that it is difficult to adapt to numerical simulation of lakes. A verification result of a Lake Tai water level shows that the constructed wind stress coefficient expression is more reasonable and superior. The present invention can be widely applied to the field of wind-wave-current numerical simulation studies on lakes, oceans and other waters.

### TECHNICAL FIELD

The present invention relates to the field of wind-wave-current numerical simulation studies, and in particular, to a method and system for a wind stress coefficient expression by comprehensively considering impacts of an average wind speed, a fetch and a water depth.

### BACKGROUND

In field observation and research on lakes and oceans, there are limitations from observation instruments and methods and many uncontrollable factors, which mostly feature short duration and local measurement. Acquired data usually has large system errors, and lacks data integrity and systematicness. Using a numerical simulation method to study characteristics of lakes and oceans can make up for the shortcomings of field observation methods to a large extent, and gain a relatively comprehensive understanding of the characteristics of lakes and oceans. Therefore, the numerical simulation method has become an important means to study hydrodynamic forces, water environments and water ecological characteristics of waters such as lakes and oceans. A wind stress coefficient represents a water-air interaction strength and efficiency of momentum transfer between water and air. As the most important model parameter in numerical simulation studies, the wind stress coefficient has a significant impact on the rationality and reliability of numerical simulation results.

The studies on the wind stress coefficient are gradually deepened with the exploration of the ocean. Due to a relatively large fetch and water depth in a marine environment, it is a priori belief in existing studies that wind-wave-current is at a mature stage and that the wind stress coefficient is related only to an average wind speed and impacts of a fetch and a water depth on the wind stress coefficient are ignored. In a scenario with a medium wind speed (5-24 m/s), currently widely used expressions of the wind stress coefficient mostly have the form of formula (1), where C_{d} is the wind stress coefficient, u₁₀ is an average wind speed at a height of 10 m above a water surface, and both a₁ and a₂ are coefficients greater than 0. This formula shows the linear positive correlation between the wind stress coefficient and the average wind speed, i.e., a greater wind speed means a greater water-air interaction strength and higher efficiency of momentum transfer between water and air.

10³C_{d}=a₁+a₂u₁₀ (1)

Existing wind stress coefficient expression methods have the following disadvantages: (1) The statistics of existing research results show that a₁ is mostly between 0.30 and 1.27, and a₂ is mostly between 0.038 and 0.138. It can be learned that a₁ and a₂ are quite different in different studies. Therefore, many alternative expressions exist in numerical simulation studies, and are highly random and empirical, resulting in the uncertainty of simulation results. (2) For lakes, offshore waters and other waters with a limited fetch and water depth, wind-wave-current is mostly in a developing stage, and a fetch and a water depth have a significant impact on efficiency of momentum transfer between water and air and water-air interaction. Therefore, it is inappropriate to still use a conventional wind stress coefficient expression in the numerical simulation studies. (3) Because wave-current characteristics are not considered, a conventional wind stress coefficient expression cannot well reflect the characteristic that when the average wind speed is high, breaking waves make the wind stress coefficient tend to be saturated with the increase of the average wind speed. Based on the above-mentioned analysis, the shortcomings of the existing expressions limit fine simulation studies on lakes, oceans and other waters, and hinder improvements to comprehensive governance capabilities.

Therefore, the existing wind stress coefficient expression method urgently needs to be further improved.

### SUMMARY

An objective of the present invention is to overcome the shortcomings of an existing wind stress coefficient expression that considers only an impact of a single factor of wind speed, and discloses a method for wind stress coefficient expression by comprehensively considering impacts of an average wind speed, a fetch and a water depth and further discloses a system based on the above-mentioned expression method. The reasonableness and superiority of an expression are verified by using a numerical simulation method.

Technical solution: A method for wind stress coefficient expression by comprehensively considering impacts of an average wind speed, a fetch and a water depth includes the following steps:
step 1: constructing a form of a wind stress coefficient expression;
step 2: determining a concrete form of the wind stress coefficient expression; and

step 3: verifying superiority of the wind stress coefficient expression.

In a further embodiment, step 1 further includes the following steps:
reflecting a wind-wave-current interaction strength by a wind stress coefficient, and obtaining the wind stress coefficient expression after considering impacts of an average wind speed, a fetch and a water depth as the wind-wave-current interaction strength is affected by the average wind speed, the fetch and the water depth:

C_{d}=f(u₁₀,F,d)

where C_{d} denotes a wind stress coefficient, u₁₀ denotes an average wind speed at a height of 10 m above a water surface, F denotes a fetch, and d denotes a water depth; and

where a water body forms wind-induced waves and surface currents under the action of wind, and a total wind stress in a water-air boundary layer is composed of a turbulent shear stress and a viscous shear stress, where the turbulent shear stress is related to disturbance of waves to airflow, and the viscous shear stress is related to the surface currents; the turbulent shear stress reflects a strength of interaction between turbulent terms in airflow and gravity waves, where the turbulent shear stress is an inertial force driving wave motion, wave gravity is a restoring force, and thus a Froude number is used to represent a strength of interaction between the turbulent terms in airflow and waves; and the viscous shear stress reflects a strength of interaction between viscous terms in airflow and the surface currents, where the viscous shear stress is a driving force, a viscous force generated after water surface slip is a restoring force, and thus a Reynolds number is used to represent the strength of the interaction between the viscous terms in airflow and the surface currents.

In a further embodiment, considering a case of a unit width water body, for any fetch F, a fetch Froude number u₁₀/(gF)^{0.5} is used to represent a strength of interaction between a turbulent shear stress of airflow and waves in a range of the fetch F; a fetch Reynolds number u₁₀F/v_{w} is used to represent a strength of interaction between a viscous shear stress of airflow and surface currents in the range of the fetch; a relative water depth d/F is constructed as a water depth characteristic of the water body; and the wind stress coefficient is represented by using the above-mentioned three dimensionless parameters to transform the wind stress coefficient expression in step 1.1 into an expression in a dimensionless form:

$${C}_{d} = f ( \frac{{u}_{10}}{\sqrt{g F}} , \frac{{u}_{10} F}{{v}_{w}} , \frac{d}{F} )$$

where g is gravitational acceleration, v_{w} is a viscosity coefficient of water, and other symbols have the same meanings as above.

In a further embodiment, for a logarithmic function, when a base is greater than 1, a dependent variable is positively correlated with an independent variable, and an increase of the dependent variable decreases with an increase of the independent variable, which is similar to a correlation between the wind stress coefficient and the average wind speed, water depth and fetch, and thus it is considered to use a natural logarithm Ln( ) as a fitting function; and referring to the existing form of the wind stress coefficient expression in step 1.1, and considering nonlinear impacts of the average wind speed, the water depth and the fetch on the wind stress coefficient, a new form of the wind stress coefficient expression is constructed as follows:

$$1 {0}^{3} {C}_{d} = {a}_{1} + {a}_{2} Ln ( {( \frac{{u}_{10}}{\sqrt{g F}} )}^{{a}_{3}} {( \frac{{u}_{10} F}{{v}_{w}} )}^{{a}_{4}} {( \frac{d}{F} )}^{{a}_{5}} )$$

where a₁ to a₅ are undetermined coefficients, and other symbols have the same meanings as above.

In a further embodiment, step 2 further includes the following steps:

performing regression based on measured data, selecting three types of data: wind tunnel test data, measured data of a water with a limited water depth and fetch and measured data of a water with deep water and a large fetch, and performing nonlinear regression analysis on a relationship between C_{d} and

$$\frac{{u}_{10}}{\sqrt{g F}} , \frac{{u}_{10} F}{{v}_{w}} and \frac{d}{F}$$

based on the above-mentioned data to obtain a fitting expression:

$$\begin{matrix}1 {0}^{3} {C}_{d} = - 3.4 \; 05 + 0.384 L n ( {( \frac{{u}_{10}}{\sqrt{g F}} )}^{0.924} {( \frac{{u}_{10} F}{{v}_{w}} )}^{0.613} {( \frac{d}{F} )}^{- 0.026} ) \\ = - 0.6 \; 50 + 0.3 \; 84 L n ( {u}_{10}^{1.53 7} {F}^{0.177} {d}^{- 0.026} )\end{matrix}$$

where it can be learned from the formula that the wind stress coefficient is positively correlated with the fetch Froude number and the fetch Reynolds number, and negatively correlated with the relative water depth.

In a further embodiment, step 3 further includes the following steps:

with Lake Tai as an object, using a numerical simulation method to establish a three-dimensional numerical model of a wind-driven current in Lake Tai by using a conventional wind stress coefficient expression and the wind stress coefficient relational expression in step 1, and comparing a simulated water level of the model with a measured water level to verify superiority of the expression in step 1.

A system for a wind stress coefficient expression by comprehensively considering impacts of an average wind speed, a fetch and a water depth includes a first module, configured to construct a form of a wind stress coefficient expression; a second module, configured to determine a concrete form of the wind stress coefficient expression; and a third module, configured to verify superiority of the wind stress coefficient expression.

In a further embodiment, the first module is further configured to reflect a wind-wave-current interaction strength, and obtain the wind stress coefficient expression after considering impacts of an average wind speed, a fetch and a water depth as the wind-wave-current interaction strength is affected by the average wind speed, the fetch and the water depth:

C_{d}=f(u₁₀,F,d)

where C_{d} denotes a wind stress coefficient, u₁₀ denotes an average wind speed at a height of 10 m above a water surface, F denotes a fetch, and d denotes a water depth;

where a water body forms wind-induced waves and surface currents under the action of wind, and a total wind stress in a water-air boundary layer is composed of a turbulent shear stress and a viscous shear stress, where the turbulent shear stress is related to disturbance of waves to airflow, and the viscous shear stress is related to the surface currents; the turbulent shear stress reflects a strength of interaction between turbulent terms in airflow and gravity waves, where the turbulent shear stress is an inertial force driving wave motion, wave gravity is a restoring force, and thus a Froude number is used to represent a strength of interaction between the turbulent terms in airflow and waves; and the viscous shear stress reflects a strength of interaction between viscous terms in airflow and the surface currents, where the viscous shear stress is a driving force, a viscous force generated after water surface slip is a restoring force, and thus a Reynolds number is used to represent the strength of the interaction between the viscous terms and the surface currents;

considering a case of a unit width water body, for any fetch F, a fetch Froude number u₁₀/(gF)^{0.5} is used to represent a strength of interaction between a turbulent shear stress of airflow and waves in a range of the fetch F; a fetch Reynolds number u₁₀F/v_{w} is used to represent a strength of interaction between a viscous shear stress of airflow and surface currents in the range of the fetch; a relative water depth d/F is constructed as a water depth characteristic of the water body; and the wind stress coefficient is represented by using the above-mentioned three dimensionless parameters to transform the wind stress coefficient expression into an expression in a dimensionless form:

$${C}_{d} = f ( \frac{{u}_{10}}{\sqrt{g F}} , \frac{{u}_{10} F}{{v}_{w}} , \frac{d}{F} )$$

where g is gravitational acceleration, v_{w} is a viscosity coefficient of water, and other symbols have the same meanings as above; and for a logarithmic function, when a base is greater than 1, a dependent variable is positively correlated with an independent variable, and an increase of the dependent variable decreases with an increase of the independent variable, which is similar to a correlation between the wind stress coefficient and the average wind speed, water depth and fetch, and thus it is considered to use a natural logarithm Ln( ) as a fitting function; and referring to the existing form of the wind stress coefficient expression, and considering nonlinear impacts of the average wind speed, the water depth and the fetch on the wind stress coefficient, a new form of the wind stress coefficient expression is constructed as follows:

$$1 {0}^{3} {C}_{d} = {a}_{1} + {a}_{2} L n ( {( \frac{{u}_{10}}{\sqrt{g F}} )}^{{a}_{3}} {( \frac{{u}_{10} F}{{v}_{w}} )}^{{a}_{4}} {( \frac{d}{F} )}^{{a}_{5}} )$$

where a₁ to a₅ are undetermined coefficients, and other symbols have the same meanings as above.

In a further embodiment, the second module is further configured to perform regression based on measured data, select three types of data: wind tunnel test data, measured data of a water with a limited water depth and fetch and measured data of a water with deep water and a large fetch, and perform nonlinear regression analysis on a relationship between C_{d} and

$$\frac{{u}_{10}}{\sqrt{g F}} , \\ \frac{{u}_{10} F}{{v}_{w}} \\ and \\ \frac{d}{F}$$

based on the above-mentioned data to obtain a fitting expression:

$$\begin{matrix}1 {0}^{3} {C}_{d} = - 3.4 \; 05 + 0.384 L n ( {( \frac{{u}_{10}}{\sqrt{g F}} )}^{0.924} {( \frac{{u}_{10} F}{{v}_{w}} )}^{0.613} {( \frac{d}{F} )}^{- 0.026} ) \\ = - 0.6 \; 50 + 0.384 L n ( {u}_{10}^{1.537} {F}^{0.177} {d}^{- 0.026} )\end{matrix}$$

where it can be learned from the formula that the wind stress coefficient is positively correlated with the fetch Froude number and the fetch Reynolds number, and negatively correlated with the relative water depth.

The third module is further configured to, with Lake Tai as an object, use a numerical simulation method to establish a three-dimensional numerical model of a wind-driven current in Lake Tai by using a conventional wind stress coefficient expression and the wind stress coefficient relational expression in the first module, and compare a simulated water level of the model with a measured water level to verify superiority of the expression in the first module.

Beneficial effects: The present invention relates to a method and system for a wind stress coefficient expression by comprehensively considering impacts of an average wind speed, a fetch and a water depth, which overcomes the shortcomings that a conventional wind stress coefficient expression considers only an impact of a single factor of wind speed, and breaks through the limitation that it is difficult to adapt to lakes and other waters that have a limited fetch and water depth. The proposed expression is used to perform numerical simulation studies, and simulation results are more in line with reality. The advantages are specifically as follows:

(1) In a process of constructing an expression, impacts of three factors: an average wind speed, a fetch and a water depth, are considered, which is more comprehensive than an existing expression, and is more in line with natural and practical characteristics of lakes, oceans and other waters.

(2) A wind-wave-current dynamic interaction mechanism is analyzed when the expression is constructed. A dimensionless Froude number and a dimensionless Reynolds number are used to represent the water-air interaction strength. The formula has clear physical meanings.

(3) In the expression, the wind stress coefficient has a nonlinear relationship with the average wind speed, the fetch and the water depth, which can well reflect the characteristic that the wind stress coefficient tends to be saturated with an increase of the average wind speed, and can also reflect that impacts of the fetch and the water depth on the wind stress coefficient are gradually weakened with increases of the fetch and the water depth.

(4) Considering the factors of the fetch and the water depth, the expression is applicable not only to lakes and wetlands with a limited fetch and water depth, but also to marine waters with a large fetch and water depth.

### BRIEF DESCRIPTION OF DRAWINGS

FIG. 1 is a conceptual diagram illustrating a wind-wave-current system of the present invention;

FIG. 2 is a diagram illustrating a comparison between values calculated using a wind stress coefficient expression of the present invention and measured values;

FIG. 3 is a diagram illustrating a comparison between values calculated using a conventional wind stress coefficient expression and measured values; and

FIG. 4 is a diagram illustrating a comparison between calculated water levels of the present invention and measured water levels.

### DESCRIPTION OF EMBODIMENTS

In the following description, numerous details are set forth to provide a more thorough understanding of the present invention. However, it will be apparent to a person skilled in the art that the present invention may be implemented without one or more of these details. In other examples, to avoid confusion with the present invention, some technical features known in the art are not described.

The present invention discloses a method and system for a wind stress coefficient expression by comprehensively considering impacts of an average wind speed, a fetch and a water depth. The method for wind stress coefficient expression specifically includes the following steps.

Step 1: Construct a form of a wind stress coefficient expression.

A wind stress coefficient reflects a wind-wave-current interaction strength, and wind-wave-current characteristics are affected by the average wind speed, the fetch and the water depth. Therefore, the wind stress coefficient may be expressed by formula (2) after impacts of the three factors are considered.

C_{d}=f(u₁₀,F,d) (2)

A water body forms wind-induced waves (wind waves) and surface currents under the action of wind, and a total wind stress in a water-air boundary layer is composed of a turbulent shear stress and a viscous shear stress, where the turbulent shear stress is related to disturbance of waves to airflow, and the viscous shear stress is related to the surface currents. The turbulent shear stress reflects a strength of interaction between turbulent terms in airflow and gravity waves, where the turbulent shear stress is an inertial force driving wave motion, wave gravity is a restoring force, and thus a Froude number may be used to represent a strength of interaction between the turbulent terms in airflow and waves. The viscous shear stress reflects a strength of interaction between viscous terms in airflow and the surface currents, where the viscous shear stress is a driving force, a viscous force generated after water surface slip is a restoring force, and thus a Reynolds number is used to represent the strength of the interaction between the viscous terms in airflow and the surface currents.

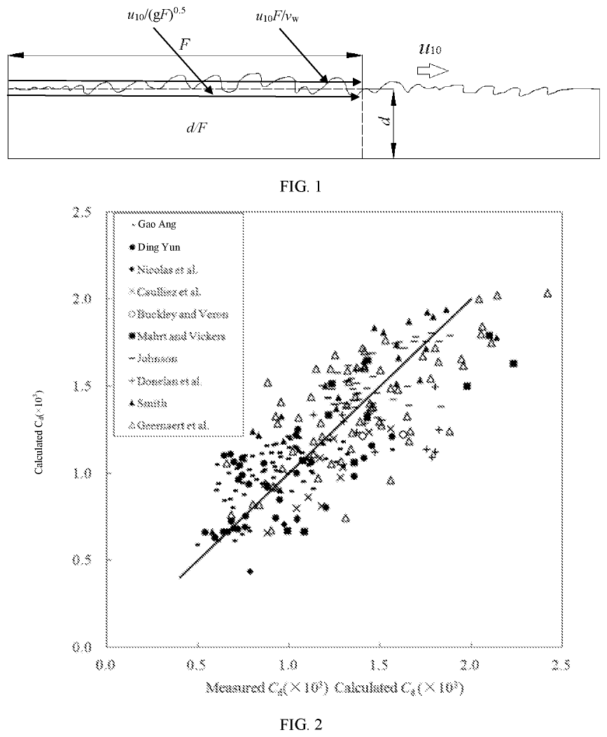

Considering a case of a unit width water body, as shown in the conceptual diagram of FIG. 1, for any fetch F, a fetch Froude number u₁₀/(gF)^{0.5} (g is gravitational acceleration) is used to represent a strength of interaction between a turbulent shear stress of airflow and waves in a range of the fetch F; and a fetch Reynolds number u₁₀F/v_{w} (v_{w} is a viscosity coefficient of water) is used to represent a strength of interaction between a viscous shear stress of airflow and surface currents in the range of the fetch. However, since u₁₀/(gF)^{0.5} and u₁₀F/v_{w} represent only a strength of dynamic interaction between airflow and an upper water body, without considering depth characteristics of the water body, a relative water depth d/F is further constructed as a water depth characteristic of the water body. The wind stress coefficient is represented by using the above-mentioned three dimensionless parameters to transform formula (2) into formula (3) in a dimensionless form.

$${C}_{d} = f ( \frac{{u}_{10}}{\sqrt{g F}} , \frac{{u}_{10} F}{{v}_{w}} , \frac{d}{F} ) \qquad ( 3 )$$

As mentioned above, at a medium wind speed, the wind stress coefficient is positively correlated with the average wind speed, and an increase of the wind stress coefficient gradually decreases with an increase of the average wind speed. In addition, the following facts further need to be considered: when the water depth and the fetch are large, they have a weak impact on the wind stress coefficient. Especially, in case of extreme offshore conditions of an infinite fetch and water depth, the impact of both may be almost ignored, and with decreases of the water depth and the fetch, the impact gradually becomes significant. For a logarithmic function, when a base is greater than 1, a dependent variable is positively correlated with an independent variable, and an increase of the dependent variable decreases with an increase of the independent variable, which is similar to a correlation between the wind stress coefficient and the average wind speed, water depth and fetch, and thus it is considered to use a logarithmic function as a fitting function. A natural logarithm Ln( ) is used in this embodiment. In addition, referring to the existing form (1) of the wind stress coefficient expression, and considering nonlinear impacts of the average wind speed, the water depth and the fetch on the wind stress coefficient, a constructed form of the wind stress coefficient expression is formula (4), where a₁ to a₅ are undetermined coefficients.

$$1 {0}^{3} {C}_{d} = {a}_{1} + {a}_{2} L n ( {( \frac{{u}_{10}}{\sqrt{g F}} )}^{{a}_{3}} {( \frac{{u}_{10} F}{{v}_{w}} )}^{{a}_{4}} {( \frac{d}{F} )}^{{a}_{5}} ) \qquad ( 4 )$$

Step 2: Determine a concrete form of the wind stress coefficient expression.

Regression needs to be performed based on measured data to determine the expression. Three types of data are selected: wind tunnel test data, measured data of a water with a limited water depth and fetch and measured data of a water with deep water and a large fetch, and the data used is shown in Table 1.

TABLE 1
Data set used for fitting

| | Number | | | | |
|---|---|---|---|---|---|
| | of | | | | |
| Data set | samples | d(m) | u₁₀(m/s) | F(m) | Type |
| Gao Ang | 70 | 0.10-0.30 | 5.3-24.0 | 10.5-19.5 | |
| Ding Yun | 31 | 0.75 | 5.5-16.8 | 7.0-36.4 | |
| Nicolas et al. | 5 | 0.30 | 5.1-15.4 | 4.5 | Test |
| Caulliez et al. | 10 | 0.90 | 6.7-17.1 | 6.0-26.0 | |
| Buckley and | 3 | 0-70 | 9.4-16.7 | 22.7 | |
| Veron | | | | | |
| Mahrt and | 11 | 4.00 | 5.0-16.0 | 4000.0- | Coast |
| Vickers | | | | 15000.0 | |
| Johnson | 49 | 3.35-3.98 | 8.8-16.4 | 15000.0- | Strait |
| | | | | 19000.0 | |
| Donelan et al. | 14 | 0.22-0.33 | 7.1-12.0 | 8000.0 | Lake |
| Smith | 85 | 59.00 | 6.1-22.0 | 10000.0- | Ocean |
| | | | | 6100000.0 | |
| Geernaert et al. | 71 | 30.00 | 5.0-24.4 | 95000.0- | Ocean |
| | | | | 704000.0 | |

Nonlinear regression analysis is performed on a relationship between C_{d} and

$$\frac{{u}_{10}}{\sqrt{g F}} , \\ \frac{{u}_{10} F}{{v}_{w}} \\ and \\ \frac{d}{F}$$

based on the above-mentioned data to obtain a fitting expression (5), where a correlation coefficient is 0.78, a determination coefficient is 0.62, and a fitting root mean square error is 0.27. This formula shows that the wind stress coefficient is positively correlated with the fetch Froude number and the fetch Reynolds number, and negatively correlated with the relative water depth. FIG. 2 shows a comparison between values calculated using this formula and measured values. It is found that the data is basically distributed on both sides of a 45° line, indicating the reasonableness of the proposed expression.

$$\begin{matrix}1 {0}^{3} {C}_{d} = - 3.4 \; 05 + 0.384 L n ( {( \frac{{u}_{10}}{\sqrt{g F}} )}^{0.924} {( \frac{{u}_{10} F}{{v}_{w}} )}^{0.613} {( \frac{d}{F} )}^{- 0.026} ) \\ = - 0.6 \; 50 + 0.3 \; 84 L n ( {u}_{10}^{1.53 7} {F}^{0.177} {d}^{- 0.026} )\end{matrix} \qquad ( 5 )$$

Step 3: Verify superiority of the wind stress coefficient expression.

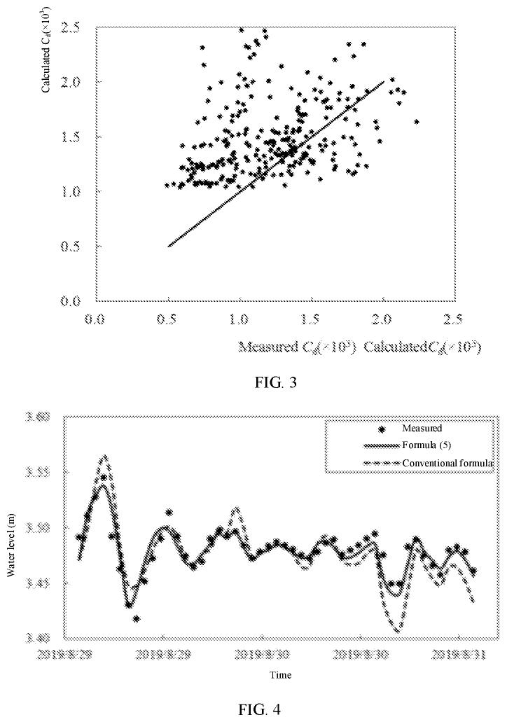

Sample data the same as that in FIG. 2 is used. A comparison between wind stress coefficient values calculated based on the conventional wind stress coefficient expression and measured values is shown in FIG. 3. it can be learned that the data is more difficult to distribute on both sides of the 45° line, and a degree of dispersion is obviously greater than that in FIG. 2, which shows that it is inappropriate to consider only the single factor of wind speed when the wind stress coefficient expression is constructed, thereby verifying the superiority of the expression proposed in the present invention. With Lake Tai as an object, a numerical simulation method is used to establish a three-dimensional numerical model of a wind-driven current in Lake Tai by using a conventional wind stress coefficient expression (scenario 1) and the wind stress coefficient relational expression (scenario 2) proposed in the present invention, and a simulated water level of the model is compared with a measured water level to verify the superiority of the expression proposed in the present invention.

FIG. 4 shows a comparison between water levels measured by Xishan gauging station of Lake Tai and simulated water levels in two scenarios. The maximum change amplitude of water levels measured during the period was 0.128 m. On the whole, the agreement between simulated results obtained using formula (5) and measured results is better than the agreement between simulated results obtained using a conventional expression and the measured results. Further, a root mean square error (RMSE) of the simulated values and the measured values in the two scenarios were calculated separately, and the RMSE in scenario 1 was 0.0181 and the RMSE in scenario 2 was 0.0095, indicating that the water level simulation accuracy of formula (5) was improved by about one time.

As mentioned above, although the present invention has been shown and described with reference to specific preferred embodiments, it should not be construed as a limitation on the present invention itself. Various changes in form and details may be made to the present invention without departing from the spirit and scope of the present invention as defined by the appended claims.

What is claimed is:

1. A method for wind stress coefficient expression by comprehensively considering impacts of an average wind speed, a fetch and a water depth, comprising the following steps:
step 1: constructing a form of a wind stress coefficient expression;
step 2: determining a concrete form of the wind stress coefficient expression; and
step 3: verifying superiority of the wind stress coefficient expression.

2. The method for wind stress coefficient expression by comprehensively considering impacts of an average wind speed, a fetch and a water depth according to claim 1, wherein step 1 further comprises the following steps:
reflecting a wind-wave-current interaction strength by a wind stress coefficient, and obtaining the wind stress coefficient expression after considering impacts of an average wind speed, a fetch and a water depth as the wind-wave-current interaction strength is affected by the average wind speed, the fetch and the water depth:
C_{d}=f(u₁₀,F,d)
wherein C_{d} denotes a wind stress coefficient, u₁₀ denotes an average wind speed at a height of 10 m above a water surface, F denotes a fetch, and d denotes a water depth; and
where a water body forms wind-induced waves and surface currents under the action of wind, and a total wind stress in a water-air boundary layer is composed of a turbulent shear stress and a viscous shear stress, where the turbulent shear stress is related to disturbance of waves to airflow, and the viscous shear stress is related to the surface currents; the turbulent shear stress reflects a strength of interaction between turbulent terms in airflow and gravity waves, where the turbulent shear stress is an inertial force driving wave motion, wave gravity is a restoring force, and thus a Froude number is used to represent a strength of interaction between the turbulent terms in airflow and waves; and the viscous shear stress reflects a strength of interaction between viscous terms in airflow and the surface currents, where the viscous shear stress is a driving force, a viscous force generated after water surface slip is a restoring force, and thus a Reynolds number is used to represent the strength of the interaction between the viscous terms in airflow and the surface currents.

3. The method for wind stress coefficient expression by comprehensively considering impacts of an average wind speed, a fetch and a water depth according to claim 2, wherein considering a case of a unit width water body, for any fetch F, a fetch Froude number u₁₀/(gF)^{0.5} is used to represent a strength of interaction between a turbulent shear stress of airflow and waves in a range of the fetch F; a fetch Reynolds number u₁₀F/v_{w} is used to represent a strength of interaction between a viscous shear stress of airflow and surface currents in the range of the fetch; a relative water depth d/F is constructed as a water depth characteristic of the water body; and the wind stress coefficient is represented by using the above-mentioned three dimensionless parameters to transform the wind stress coefficient expression in step 1.1 into an expression in a dimensionless form:
$${C}_{d} = f ( \frac{{u}_{10}}{\sqrt{g F}} , \frac{{u}_{10} F}{{v}_{w}} , \frac{d}{F} )$$
wherein g is gravitational acceleration, v_{w} is a viscosity coefficient of water, and other symbols have the same meanings as above.

4. The method for wind stress coefficient expression by comprehensively considering impacts of an average wind speed, a fetch and a water depth according to claim 2, wherein for a logarithmic function, when a base is greater than 1, a dependent variable is positively correlated with an independent variable, and an increase of the dependent variable decreases with an increase of the independent variable, which is similar to a correlation between the wind stress coefficient and the average wind speed, water depth and fetch, and thus it is considered to use a natural logarithm Ln( ) as a fitting function; and referring to the existing form of the wind stress coefficient expression in step 1.1, and considering nonlinear impacts of the average wind speed, the water depth and the fetch on the wind stress coefficient, a new form of the wind stress coefficient expression is constructed as follows:
$$1 {0}^{3} {C}_{d} = {a}_{1} + {a}_{2} L n ( {( \frac{{u}_{10}}{\sqrt{g F}} )}^{{a}_{3}} {( \frac{{u}_{10} F}{{v}_{w}} )}^{{a}_{4}} {( \frac{d}{F} )}^{{a}_{5}} )$$
wherein a₁ to a₅ are undetermined coefficients, and other symbols have the same meanings as above.

5. The method for wind stress coefficient expression by comprehensively considering impacts of an average wind speed, a fetch and a water depth according to claim 4, wherein step 2 further comprises the following steps:
performing regression based on measured data, selecting three types of data: wind tunnel test data, measured data of a water with a limited water depth and fetch and measured data of a water with deep water and a large fetch, and performing nonlinear regression analysis on a relationship between C_{d} and
$$\frac{{u}_{10}}{\sqrt{g F}} , \\ \frac{{u}_{10} F}{{v}_{w}} \\ and \\ \frac{d}{F}$$
based on the above-mentioned data to obtain a fitting expression:
$$\begin{matrix}1 {0}^{3} {C}_{d} = - 3.4 \; 05 + 0.384 L n ( {( \frac{{u}_{10}}{\sqrt{g F}} )}^{0.924} {( \frac{{u}_{10} F}{{v}_{w}} )}^{0.613} {( \frac{d}{F} )}^{- 0.026} ) \\ = - 0.6 \; 50 + 0.384 Ln ( {u}_{10}^{1.53 7} {F}^{0.177} {d}^{- 0.026} )\end{matrix}$$
wherein it can be learned from the formula that the wind stress coefficient is positively correlated with the fetch Froude number and the fetch Reynolds number, and negatively correlated with the relative water depth.

6. The method for wind stress coefficient expression by comprehensively considering impacts of an average wind speed, a fetch and a water depth according to claim 1, wherein step 3 further comprises the following steps:
with Lake Tai as an object, using a numerical simulation method to establish a three-dimensional numerical model of a wind-driven current in Lake Tai by using a conventional wind stress coefficient expression and the wind stress coefficient relational expression in step 1, and comparing a simulated water level of the model with a measured water level to verify superiority of the expression in step 1.

7. A system for a wind stress coefficient expression by comprehensively considering impacts of an average wind speed, a fetch and a water depth, comprising the following modules:
a first module, configured to construct a form of a wind stress coefficient expression;
a second module, configured to determine a concrete form of the wind stress coefficient expression; and
a third module, configured to verify superiority of the wind stress coefficient expression.

8. The system for a wind stress coefficient expression by comprehensively considering impacts of an average wind speed, a fetch and a water depth according to claim 7, wherein
the first module is further configured to reflect a wind-wave-current interaction strength, and obtain the wind stress coefficient expression after considering impacts of an average wind speed, a fetch and a water depth as the wind-wave-current interaction strength is affected by the average wind speed, the fetch and the water depth:
C_{d}=f(u₁₀,F,d)
wherein u₁₀ denotes an average wind speed at a height of 10 m above a water surface, F denotes a fetch, and d denotes a water depth;
where a water body forms wind-induced waves and surface currents under the action of wind, and a total wind stress in a water-air boundary layer is composed of a turbulent shear stress and a viscous shear stress, where the turbulent shear stress is related to disturbance of waves to airflow, and the viscous shear stress is related to the surface currents; the turbulent shear stress reflects a strength of interaction between turbulent terms in airflow and gravity waves, where the turbulent shear stress is an inertial force driving wave motion, wave gravity is a restoring force, and thus a Froude number is used to represent a strength of interaction between the turbulent terms in airflow and waves; and the viscous shear stress reflects a strength of interaction between viscous terms in airflow and the surface currents, where the viscous shear stress is a driving force, a viscous force generated after water surface slip is a restoring force, and thus a Reynolds number is used to represent the strength of the interaction between the viscous terms and the surface currents;
considering a case of a unit width water body, for any fetch F, a fetch Froude number u₁₀/(gF)^{0.5} is used to represent a strength of interaction between a turbulent shear stress of airflow and waves in a range of the fetch F; a fetch Reynolds number u₁₀F/v_{w} is used to represent a strength of interaction between a viscous shear stress of airflow and surface currents in the range of the fetch; a relative water depth d/F is constructed as a water depth characteristic of the water body; and the wind stress coefficient is represented by using the above-mentioned three dimensionless parameters to transform the wind stress coefficient expression into an expression in a dimensionless form:
$${C}_{d} = f ( \frac{{u}_{10}}{\sqrt{g F}} , \frac{{u}_{10} F}{{v}_{w}} , \frac{d}{F} )$$
wherein g is gravitational acceleration, v_{w} is a viscosity coefficient of water, and other symbols have the same meanings as above; and
for a logarithmic function, when a base is greater than 1, a dependent variable is positively correlated with an independent variable, and an increase of the dependent variable decreases with an increase of the independent variable, which is similar to a correlation between the wind stress coefficient and the average wind speed, water depth and fetch, and thus it is considered to use a natural logarithm Ln( ) as a fitting function; and referring to the existing form of the wind stress coefficient expression, and considering nonlinear impacts of the average wind speed, the water depth and the fetch on the wind stress coefficient, a new form of the wind stress coefficient expression is constructed as follows:
$$1 {0}^{3} {C}_{d} = {a}_{1} + {a}_{2} L n ( {( \frac{{u}_{10}}{\sqrt{g F}} )}^{{a}_{3}} {( \frac{{u}_{10} F}{{v}_{w}} )}^{{a}_{4}} {( \frac{d}{F} )}^{{a}_{5}} )$$
wherein a₁ to a₅ are undetermined coefficients, and other symbols have the same meanings as above.

9. The system for a wind stress coefficient expression by comprehensively considering impacts of an average wind speed, a fetch and a water depth according to claim 7, wherein
the second module is further configured to perform regression based on measured data, select three types of data: wind tunnel test data, measured data of a water with a limited water depth and fetch and measured data of a water with deep water and a large fetch, and perform nonlinear regression analysis on a relationship between C_{d} and
$$\frac{{u}_{10}}{\sqrt{g F}} , \\ \frac{{u}_{10} F}{{v}_{w}} \\ and \\ \frac{d}{F}$$
based on the above-mentioned data to obtain a fitting expression:
$$\begin{matrix}1 {0}^{3} {C}_{d} = - 3.4 \; 05 + 0.384 L n ( {( \frac{{u}_{10}}{\sqrt{g F}} )}^{0.924} {( \frac{{u}_{10} F}{{v}_{w}} )}^{0.613} {( \frac{d}{F} )}^{- 0.026} ) \\ = - 0.6 \; 50 + 0.384 Ln ( {u}_{10}^{1.53 7} {F}^{0.177} {d}^{- 0.026} )\end{matrix}$$
wherein it can be learned from the formula that the wind stress coefficient is positively correlated with the fetch Froude number and the fetch Reynolds number, and negatively correlated with the relative water depth.

10. The system for a wind stress coefficient expression by comprehensively considering impacts of an average wind speed, a fetch and a water depth according to claim 7, wherein
The third module is further configured to, with Lake Tai as an object, use a numerical simulation method to establish a three-dimensional numerical model of a wind-driven current in Lake Tai by using a conventional wind stress coefficient expression and the wind stress coefficient relational expression in the first module, and compare a simulated water level of the model with a measured water level to verify superiority of the expression in the first module.
